(19) United States
(12) Patent Application Publication
(10) Pub. No.: US 2013/0144880 A1
(43) Pub. Date: Jun. 6, 2013

(54) BUSINESS PARTNER GROUPING

(71) Applicants: Johann Kemmer, Muhlhausen (DE); Martina Rothley, Schwetzingen (DE)

(72) Inventors: Johann Kemmer, Muhlhausen (DE); Martina Rothley, Schwetzingen (DE)

(21) Appl. No.: 13/312,513

(22) Filed: Dec. 6, 2011

(51) Int. Cl. G06F 17/30

(52) U.S. Cl. 707/737; 707/E17.01

(57) ABSTRACT

A method and system, the method including defining business criteria for business entities, the business criteria including at least one business object attribute; defining at least one business partner group set, each of the at least one business partner group set being associated with at least one business object attribute selected from the business criteria; and modifying, by the computer, a record of a business entity by assigning the business entity to one or more of the defined business partner group sets.

### FIELD

Some embodiments relate to business application data within a business application platform. More specifically, some embodiments relate to the grouping of business partner application data and the use of the business partner groupings in business applications in a business application platform.

### BACKGROUND

Enterprise computing systems are commonly used to provide business services to business users. An enterprise computing system may provide one or more of enterprise resource management, customer relationship management, human resource management, supply chain management, accounting, or other applications or services to business users. The term “business application platform” will be used herein to encompass all types of computing systems for providing business services.

A business application platform may integrate multiple business organizations and functions of an enterprise by, for example, supporting and maintaining an exchange of information between various business systems and organizations. Business entities or business partners interacting with or otherwise having a role in a business process of the enterprise may interact with one or more other business partners and/or business applications and services. The business application platform may typically use a database or other information repository to maintain data records related to each of the business partners having a relationship with the enterprise. In some aspects, the business partner records may be integrated into the various business systems of the enterprise.

A business may desire to have certain business settings, terms and/or conditions apply to certain specific business partners it supports and to which it provides services. However, making changes to business partner associated settings for a select number of business partners may be technically difficult in the case of integrated business application platforms. In some scenarios, setting changes to business partner records may be effectuated for all of the business partners, while in other scenarios only the data records for each business partner may be individually modified. A difficulty with updating or modifying business partner records individually is that such a process is time-consuming and inefficient, particularly when an enterprise may have hundreds or thousands of business partners including business partners internal and external to the enterprise.

### BRIEF DESCRIPTION OF THE DRAWINGS

FIG. 1 is a block diagram of a system, according to some embodiments.

FIG. 2 is a flow diagram of a process, according to some embodiments.

FIG. 3A is a view of an abstract user interface for defining business criteria, according to some embodiments.

FIG. 3B is a view of an illustrative example of the user interface of FIG. 3A, according to some embodiments.

FIG. 4 is a view of a user interface for defining business partner group sets, according to some embodiments.

FIG. 5 is a view of a user interface illustrating exemplary aspects of FIG. 4, according to some embodiments.

FIG. 6 is a view of a user interface, according to some embodiments.

FIG. 7 is a flow diagram of a process, according to some embodiments.

FIG. 8 is a view of a user interface, according to some embodiments.

FIG. 9 is a view of a user interface, according to some embodiments.

FIG. 10 is a view of a user interface for an assignment of business partner group sets to selected business partners, according to some embodiments;

FIG. 11 is a view of a user interface including a display of business partner group sets, according to some embodiments.

FIG. 12 an illustrative diagram depicting interdependencies between various entities herein, according to some embodiments.

FIG. 13 is a block diagram of an apparatus, according to some embodiments.

### DETAILED DESCRIPTION

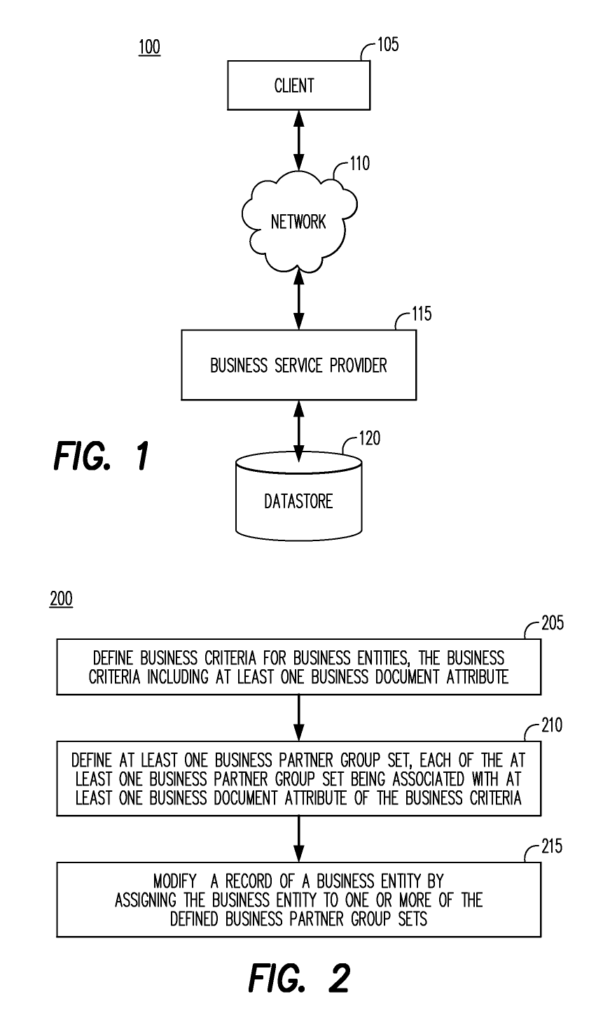

FIG. 1 is a block diagram of a system 100 according to some embodiments. In this case, a business service provider might host and provide business applications and services at business application platform 115 for a client 105. For example, a business service provider may receive requests from the client 105 via communication network 110 and provide responses to client 105 via a service-oriented architecture such as those provided by SAP Business ByDesign®. Note that the business application platform 115 might include any backend system, including backend systems that belong to the client 105, those that belong to (or are administered by) service providers of business application platform 115, those that are web services, etc.

Client 105 may interact with a Web browser to access services provided by business application 115 via HyperText Transport Protocol (HTTP) communication. For example, a user may manipulate a user interface of client 105 to select data items that indicate an instruction (e.g., “show me just this data”). Client 105, in response, may transmit a corresponding HTTP service request to a business service provider at business application platform 115 as illustrated. A service-oriented architecture may conduct any processing required by the request (e.g., generating queries and executing the queries against a collection of data as defined by a business application) and, after completing the processing, provides a response (e.g., search results) to client 105. Client 105 may comprise a Personal Computer (PC) or mobile device executing a Web client. Examples of a Web client include, but are not limited to, a Web browser, an execution engine (e.g., JAVA, Flash, Silverlight) to execute associated code in a Web browser, and/or a dedicated standalone application.

In some aspects, FIG. 1 represents a logical architecture supportive of processes herein according to some embodiments, and actual implementations may include more or different elements arranged in other manners. Moreover, each system described herein may be implemented by any number of devices in communication via any number of other public and/or private networks. Two or more of the devices herein may be co-located, may be a single device, or may be located remote from one another and may communicate with one another via any known manner of network(s) and/or a dedicated connection. Moreover, each device may comprise any number of hardware and/or software elements suitable to provide the functions described herein as well as any other functions. Other topologies may be used in conjunction with other embodiments.

All systems and processes discussed herein may be embodied in program code stored on one or more non-transitory computer-readable media. Such media may include, for example, a flash drive, a CD-ROM, a DVD-ROM, magnetic tape, and solid state Random Access Memory (RAM) or Read Only Memory (ROM) storage units. According to some embodiments, a memory storage unit may be associated with access patterns and may be independent from the device (e.g., magnetic, optoelectronic, semiconductor/solid-state, etc.) Moreover, in-memory technologies may be used such that databases, etc. may be completely operated in RAM memory at a processor. Embodiments are therefore not limited to any specific combination of hardware and software.

Client 105 may provide a user interface for presenting user-selectable options to a user and receiving an indication of a selection of one or more of the data items presented in the user interface. In some embodiments, the data may be associated with settings, terms, tolerances, and other aspects of a business document or other data structures hosted by business application platform 115. The entry of a selection of data into a user interface of client 105 may, in some cases, be completely accomplished without entry of text by the user and without using additional tools or other screens. Instead, the entry of the user's selections of data items is made by the user directly manipulating the data presented in the user interface. For example, the user may highlight user interface data items using a mouse or other input pointing device (e.g., track pad) to directly select a number of data items from a previous search result. The backend system, provided as part of or in cooperation with a business service provider of business application platform 115, may in turn use the selected data items to define and group business partners into different groups, where the different groups have different attributes associated therewith.

Accordingly, a method and mechanism for efficiently and automatically defining, creating, and instantiating business partner groups based on a selection of data items selected via a user interface are provided by some embodiments herein. In some aspects, some example business partner groupings may include grouping business partners based on or according to the business partners having, for example, common supplier tolerances (e.g., over and under delivery tolerances); delivery terms, payment terms, payment methods, and payment strategies; the responsible freight forwarder for suppliers in different countries; the responsible invoicer for a set of suppliers; the mode of communication used for a set of customers or suppliers (e.g., email, interactive chat, etc.); a value ranking scheme (e.g., “A/B/C” ranking of suppliers); and customizable groupings.

It should be appreciated that the example user interfaces herein are provided to illustrate certain aspects of the present disclosure and do not represent an exclusive or exhaustive disclosure of those same aspects.

In some aspects, the information maintained for each business partner may be integrated into a business application platform, including one or more discrete applications or a suite of applications; may include detailed data of any type and scope; may be associated with business partners internal and external to a business organization or entity; and is, generally, referred to herein a master data record for the business partner. Business partner master data records may be used to import data related to a business partner or a group of business partners into a business document. In some aspects, a business application may be triggered to operate in a certain manner depending on business partner data imported into a business document. For example, exceeding an over delivery tolerance setting associated with a purchase order for a business partner may trigger an enterprise resource planning (ERP) application to send an alert to a manager. In some embodiments, master data records may be centrally maintained by, for example, a back-end system.

FIG. 2 is an illustrative flow diagram of a process 200, according to some embodiments herein. Process 200 discloses a method and mechanism to flexibly group business partners according to different business criteria, according to some embodiments herein. In some aspects, a plurality of business applications might be integrated with each other. As used herein, integrated business applications may, at least, interact with each other and share access to master data records associated with business partners that might be used in one or more of the integrated business applications.

At operation 205, business criteria for business entities is defined. The business criteria defined at 205 may include at least one attribute associated with at least one business document. In accordance with some embodiments, a business document may include structured data, unstructured data, or both structured and unstructured data and the business document attributes may comprise a wide variety and types of data without limit. In some aspects, the business criteria may be flexibly defined without predetermined limitations on the scope and variety of the business criteria. In some embodiments, the business partners (i.e., entities) may be, relative to a business organization or entity, internal business partners or external business partners.

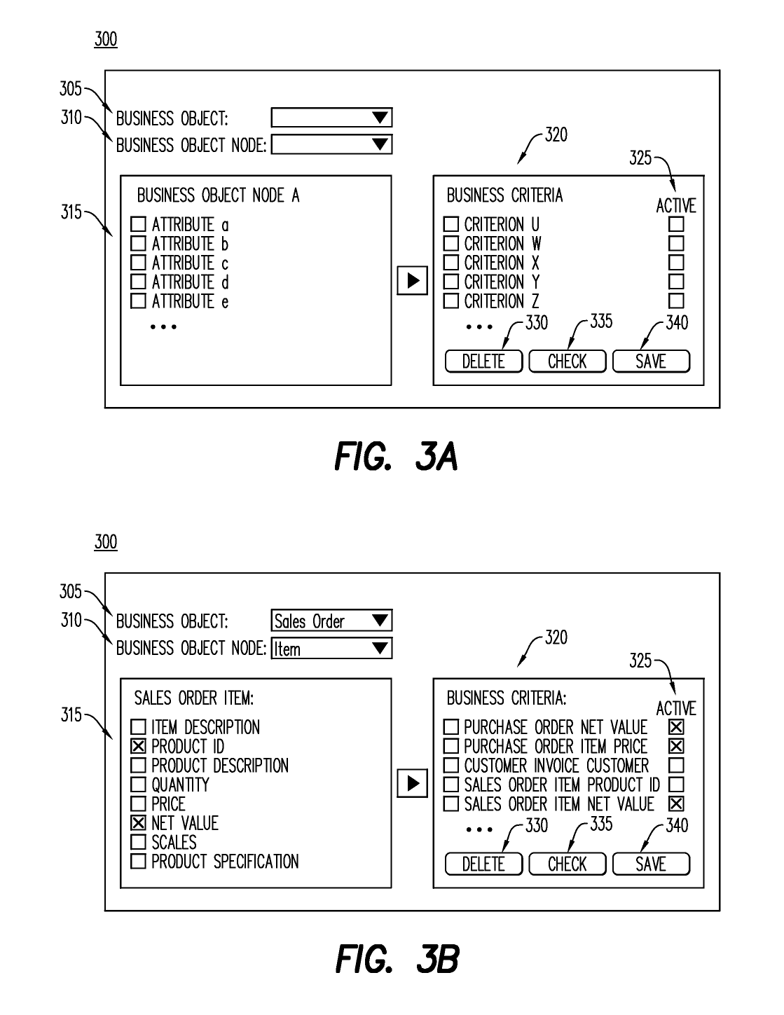

FIG. 3A is an illustrative example of a user interface (UI) 300 including a number of graphical elements to facilitate defining business criteria. In some embodiments, UI 300 may facilitate the defining of business criteria shown at operation 205 of process 200. UI 300 may provide a mechanism for a user to define business criteria by selecting or otherwise indicating the business attributes to include in the business criteria being defined therein. The business attributes included in the business criteria may be automatically proposed in business document definitions or invoke business application behavior at a run time of a business application using the business documents (as will be explained in greater detail below). In some embodiments, the business attributes to be included in a definition of business criteria may be selected from preexisting business documents used in business applications. In some other embodiments, the business attributes to be included in a definition of business criteria may be defined in parallel with the defining of the business documents.

As shown at 305 of FIG. 3A, UI 300 may include a mechanism or user interface (UI) element to select or otherwise indicate one or more business objects (e.g., a listing) from which business object (BO) attributes may be selected for defining business criteria. As used herein, a business object (BO) refers to a data structure having fields with attributes, including a number of interrelated nodes. In general, a BO may represent a business process including a number of interrelated nodes representative of business documents, data items, and methods. In some embodiments, the attributes may be described by metadata. The BO nodes associated with a BO (e.g., SALES ORDER) selected at 305 may be presented at UI element 310. Upon selection of a BO node at 310, the attributes associated therewith may be automatically presented at display panel 315. Further, one or more of the attributes at 315 may be selected for inclusion in the criteria presented at display panel 320. In the example of FIG. 3A, a plurality of attributes corresponding to or associated with the selected BO node A are presented at UI 315 (e.g., ATTRIBUTE a, ATTRIBUTE b, ATTRIBUTE c, etc.) Each of the attributes selected at UI 315 (e.g., “x” to indicate a selection) for defining business criteria corresponds to a business criterion presented in the display pane of UI 320. One or more business criteria may be defined in the example UI 300 of FIG. 3A by selecting one or more of attributes at UI 315.

In some embodiments, the business criteria defined in UI 300 may be released for use in accordance with other aspects herein by selecting one or more of the business criteria (e.g., CRITERION U, CRITERION W, CRITERION X, etc.) using UI elements 325 to “activate” the desired business criteria. In some embodiments, the business criteria at 320 may be activated upon creation of the business criteria. In some aspects, business criteria may be defined during a business system configuration by, for example, a business application expert or it may be defined during a delta configuration of the system, although not limited to those scenarios. In some embodiments, business criteria may be deleted by actuating UI element 330, checked for operational compatibility by selecting UI element 335, and persisted to a data store by selecting UI element 340.

In some aspects, flexibility in defining business criteria is demonstrated in the UI 300 of FIG. 3A since any one or more selected attributes may be selected for comprising the business criteria (e.g., “CRITERION U”, “CRITERION W”, “CRITERION X”, etc.). UI 300 may also provide the ability to select one or more different business objects and collect the selected business attributes as business criteria. That is, UI 300 may provide a mechanism to build the list of business criteria by selecting business attributes from various different business objects and business object nodes associated with those different BOs.

FIG. 3B is similar to FIG. 3A but for the fact that UI 300 may be viewed as an example of a use-case of the illustrative abstract UI 300 of FIG. 3A. As such, specific though not limiting, illustrative examples of BO 305, BO node 310, attributes 315, and business criteria 320 are depicted in FIG. 3B.

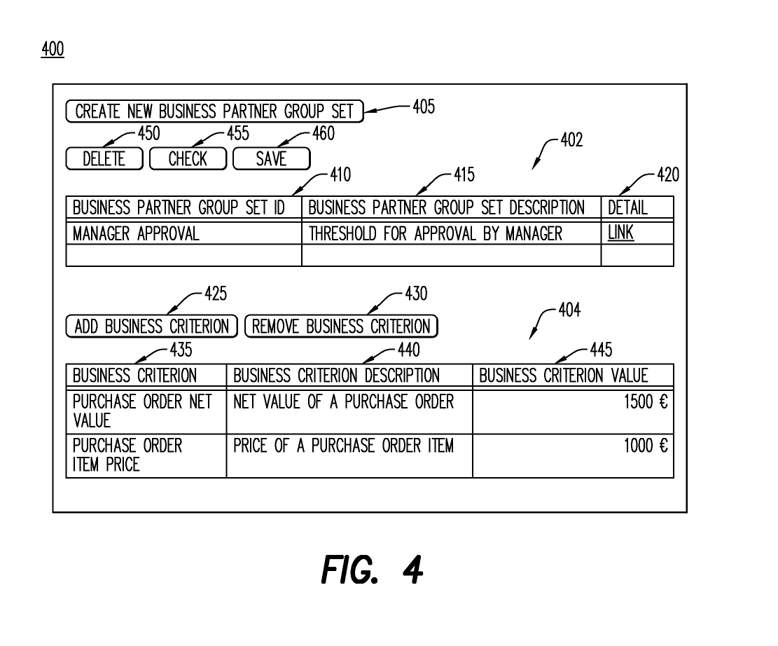

Referring back to FIG. 2, at least one business partner group set may be defined at operation 210. In some embodiments, each of the at least one business partner group sets defined at operation 210 may be associated with at least one of the business attributes of the business criteria defined at operation 205. FIG. 4 provides an illustrative example of a UI 400, including a number of graphical UI elements to facilitate defining business partner group sets. A discussion of operation 210 will be provided below while also referencing FIG. 4.

UI 400 includes graphical elements for creating a business partner group set by actuating UI element 405; and at table or UI element 402 selecting, inputting, or otherwise indicating a business partner group set ID at 410; specifying a business partner group set description at 415 (optional in some embodiments); and providing additional detail(s) at 420. A business partner group set may be deleted, checked, or saved or otherwise maintained by invoking UI buttons 450, 455, and 460, respectively. Table 404 provides a listing of individual business criterion and their related values associated with the business partner group set(s) identified in table 402. In the example of FIG. 4, the business partner group set having the business partner group set ID 410 of “MANAGER APPROVAL” may be associated with the two business criterion detailed in table 404. Accordingly, the example “MANAGER APPROVAL” business partner group set ID includes the business criterion shown at 435 having the descriptions shown at 440 and the respective attribute values depicted at 445. The business partner group set ID at 410 may comprise a key identifier to be used to reference a particular business partner group set. In some aspects, the business partner group set ID may be a unique identifier including any combination of numeric and alphanumeric characters and other indicia. The description at 415 may be a word or phrase that describes or labels the business partner group set. In the detail(s) at 420, the business criteria are assigned to the business partner group set. The business criterion listed at 435 may be selected from the previously defined business criteria (e.g., defined at FIG. 2, operation 205 and illustrated by the example of FIG. 3B). For example, business criterion listed at 435 may include “PURCHASE ORDER NET VALUE”, “PURCHASE ORER ITEM PRICE”, etc. In some embodiments, business criterion may not be available for presentation and/or selection at UI 435 until the business criterion including the business attributes of operation 205 are “activated” (e.g., FIGS. 3A and 3B, UI element 325).

A business criterion value may be assigned to each business criterion associated with a business partner group set at 445. In some aspects, the business criterion value may include any combination of value expressions, including numerical, mathematical, and logical expressions. In some aspects herein, the values assigned to the business criterion at 445 may later be automatically proposed in a business document/application/solution interacting with a business partner assigned to the business partner group set(s) defined at operation 210 (explained in greater detail below). In some embodiments, more than one business criterion may be assigned or associated with a business partner group set.

In some embodiments, business partner group sets may be defined in a table-like format of the type depicted in FIG. 4. However, the data structure and representation thereof need not conform to the specific example of FIG. 4. Notwithstanding the configuration of the business partner group set defined at operation 210 of process 200 herein, a business partner group set may be deleted by invoking UI element 450, checked for operational compatibility by selecting UI element 455, and persisted to a data store by activating UI element 460, in some embodiments. In some embodiments, attributes may be added or removed from a business partner group set by selecting “Add Business Attribute” UI button 425 or “Delete Business Attribute” UI button 430, respectively. In some aspects, business partner group sets may be defined during a business system configuration by, for example, a business application expert or they may be defined during a delta configuration or an editing of an existing business partner group set, although not limited to these scenarios alone.

In some embodiments, business partner group sets herein may support hierarchical features wherein business partner groups may be ranked or otherwise have a relative hierarchical order relative to other business partner groupings. As such, a lower ranking related business partner grouping (i.e., a child group) may inherit the attributes of a higher ranking related business partner grouping (i.e., a parent group).

Having defined a business partner group set as indicated at operation 210, the business partner group set may be activated for release and usage in or by other processes. In some embodiments, the business partner group sets defined as disclosed herein may be activated for release upon creation thereof or may be activated after affirmative activation by a user, administrator, system designer, or other entity.

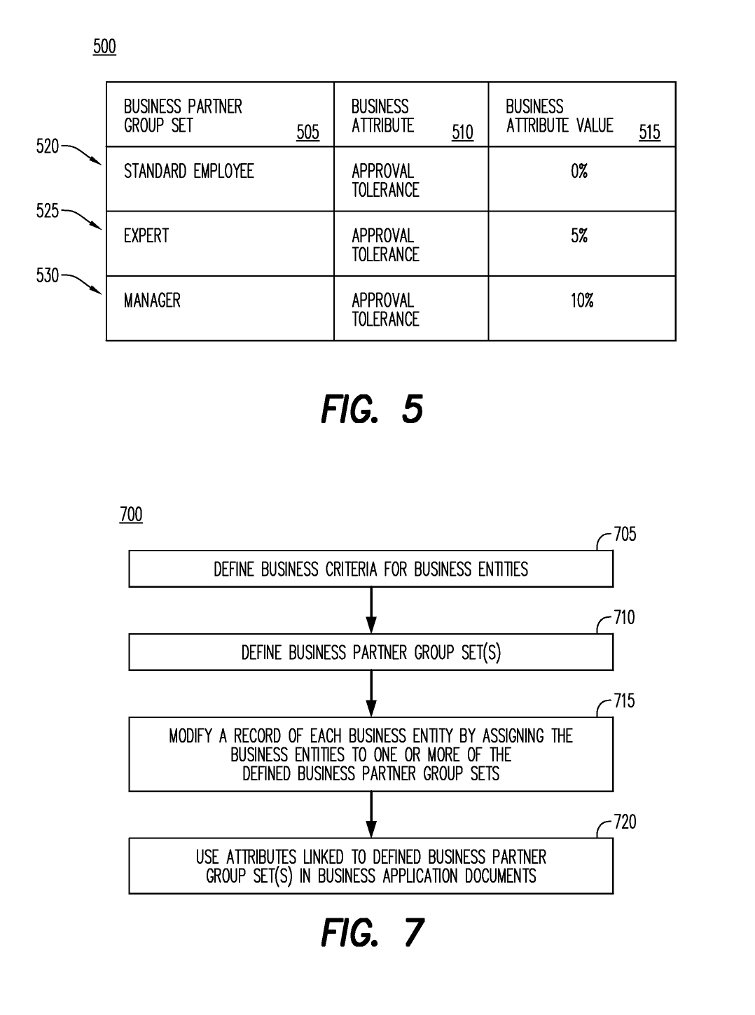

FIG. 5 is an illustrative depiction of a UI 500 that includes a number of example business partner group sets at 505. Each of the example business partner group sets 520, 525, and 530 has a business attribute associated therewith at 510 and each business attribute has an associated business attribute value at 515. The business partner group sets of UI 500 relate to three different tolerance groups for employees (i.e., internal business partners) of a business entity. The depicted business partner group sets may group the employees into one of three groups, “Standard Employee” group set 520, “Expert” group set 525, and “Manager” group set 530. As used herein, the key identifier for the business partner group sets of the FIG. 5 example include the keys “Standard Employee”, “Expert”, and “Manager”. Each of the business partner group sets is associated with an “Approval Tolerance” attribute that dictates the magnitude of the deviations that business partners belonging to that business partner group are authorized to approve. For example, an employee assigned to the “Standard Employee” business partner group may not approve any deviations from an expected outcome, whereas an “Expert” business partner group member may approve of deviations as great as 5% and an employee assigned to the “Manager” business partner group set may approve of deviations varying as much as 10% from an expected norm.

Referencing FIG. 2 again, operation 200 continues to operation 215 where a record of a business entity is modified. In some embodiments, the record is, for example, a master data record associated with the business partner that includes detailed information regarding the business partner. In some aspects, data related to a particular business partner (i.e., entity) may be persisted and stored in a master data record for that business partner. The master data record for each business partner may include information descriptive of the business partner and information that relates the business partner to business applications. For example, a master data record for a business partner may include, for example, biographical information (e.g., company name, physical address, email address, etc.), the type of industry to which the business partner belongs, and business application associated settings relevant to the business partner (e.g., billing allowances for the business partner, etc.).

The master data record of a business partner may be updated to include an indication of a business partner group assignment for the business partner. As an example and with reference to FIG. 5, an internal business partner (e.g., employee John Smith) may be assigned to the “Expert” business partner group set 525. Accordingly, the master data record associated with the business partner “John Smith” may be updated to include a field with a value representative of the “Expert” business partner group set assignment.

In some embodiments, the master data record of a business partner may be updated to include an indication of a business partner group assignment for a business partner by changing or updating an existing data field in the master data record for the business partner. Business partners may be individually assigned to business partner groups by designating their assignment to a business partner group in the master data record of the individual business partners. In some embodiments, the master data record for the business partner may be extended to include a new field (e.g., a “Group of Business Partners” field) that will be populated with a value pointing to a previously defined business partner group set (e.g., “Expert”). Whether preexisting or newly created, a data field of the business partner master data record may be used to include a pointer or reference value that indicates the business partner group set to which the business partner is assigned.

In some aspects, a change of attributes (keys and values) in the business partner group sets is automatically promulgated to the business partners assigned to the business partner group(s) having the changed attributes. Additionally, the changed attributes may be immediately used when new business documents are created and for which one of the business partners affected by the attribute change interacts or is otherwise involved.

In some embodiments, business partner groups may be assigned to business partner master data records using a mass or batch data process wherein a multiple number of business partners are selected for assignment to a business partner group simultaneously (not shown). In some aspects, the batch mode operation for assigning business partner groups may be scheduled to execute on a schedule, including in some aspects in a background environment.

In some embodiments, after the assignment of a business partner to a business partner group at 215, business attributes associated with or linked to the business partner group may be active in business applications using business documents that reference and interact with the specific business partner. The “key” identifier defined in the business partner group sets at 210 herein may be used in the business partner master data to point to the assignment of the business partner to a business partner group set, which in turn indicates the business attributes to be used in business applications referencing the business partner.

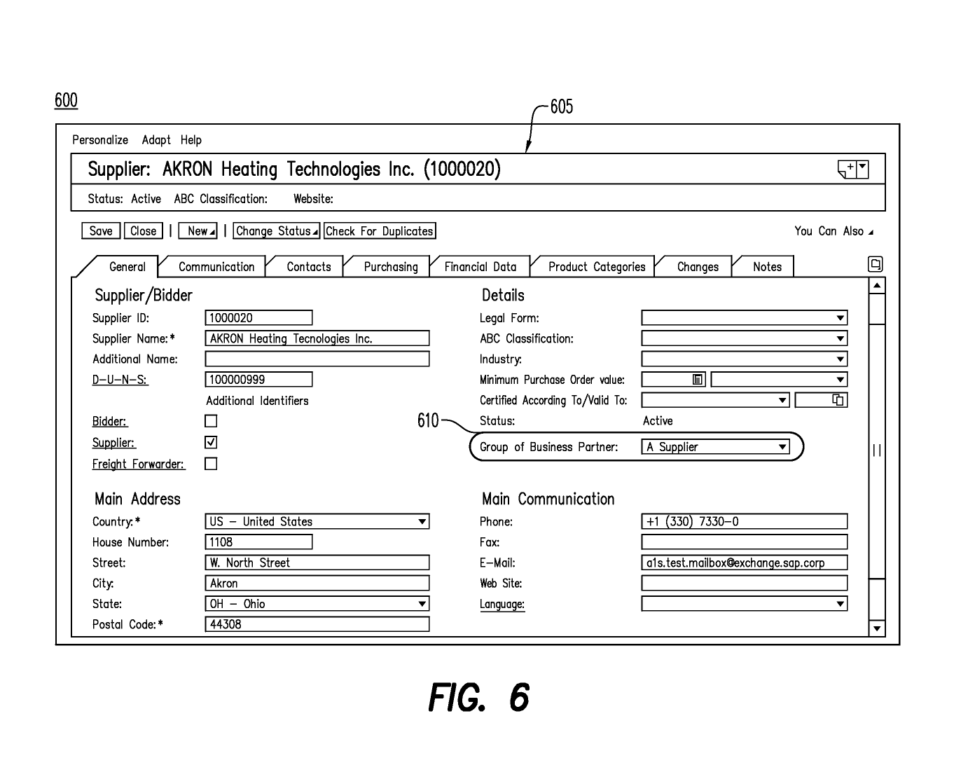

FIG. 6 is an illustrative example of a UI 600 illustrating a master data record 605 for a business partner. In the example of FIG. 6, the business partner is an external business partner, a supplier by the name of AKRON Heating Technologies, Inc. As shown at field or UI element 610, the “Group of Business Partner” field, indicates that this business partner is an “A” supplier. The designation of an “A” supplier may be consistent with an A/B/C characterization or grading of businesses that ranks a business into one of three levels. In some embodiments, business criteria may be pre-packaged or pre-delivered to include pre-defined groupings such as the aforementioned A/B/C groupings. Some embodiments including pre-delivered grouping criteria may also include user-defined business criteria as explained with regards to FIG. 2, operation 205. In embodiments including pre-delivered business criteria, the business criteria may be considered as not being “activated” until it is entered into or referenced by at least one master data record.

Due to the FIG. 6 business partner being assigned to business partner group “A supplier” as indicated at 610, the business partner there inherits or is otherwise associated with the attributes defined for and associated with the “A supplier” business partner group set. Additionally, all other business partners also assigned to the “A supplier” business partner group set also inherit the attributes defined for and associated with the business partner group set “A supplier”.

FIG. 7 is an illustrative flow diagram of a process 700, according to some embodiments herein. Process 700, in some embodiments like process 200, discloses a method and mechanism to group business partners according to different business criteria. In some aspects, operations 705, 710, and 715 may be similar to operations 205, 210, and 215, respectively. Accordingly, an understanding of operations 705, 710, and 715 may be readily had by referring to the discussion of operations 205, 210, and 215 herein. A point of distinction for process 700 from process 200 is operation 720. Operation 720 provides a mechanism to use attributes linked to defined business partner groups sets in business documents and applications. In this regard, embodiments herein may provide a mechanism to attach sets of business attributes to certain groups of suppliers or other business partners. The business attributes in turn may be transferred automatically from the business partner records of the business partners to the related business documents (e.g. a sales order) once the business partner is assigned to the business document. In this manner, the business partner may have a bundle of business attributes, in addition to attributes directly related to the business partner (e.g., address and other data), that may control a business process flow or give additional information to the user of the business documents.

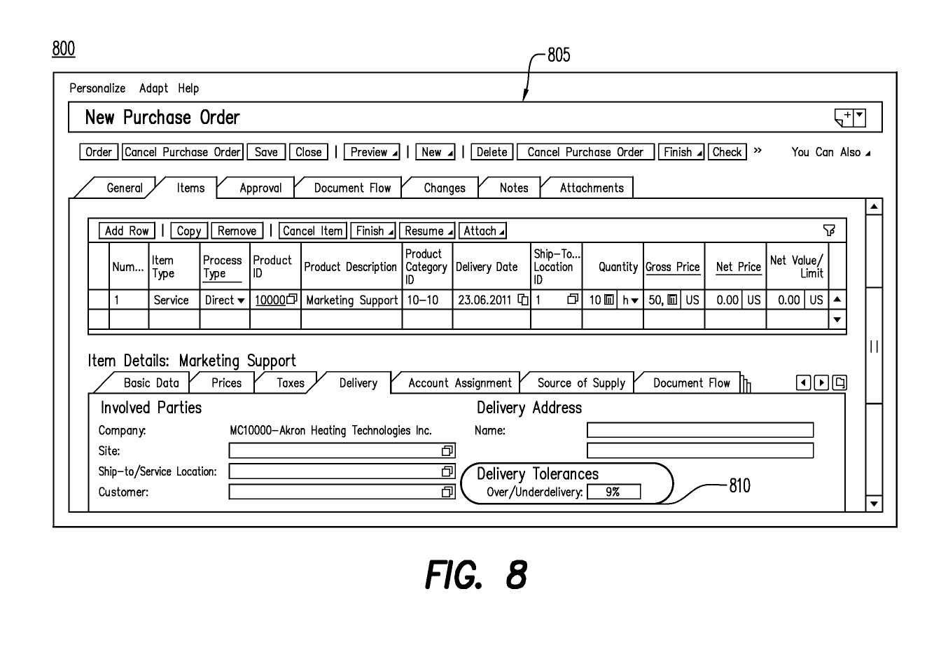

FIG. 8 provides an illustrative example of attributes linked to or associated with a business partner group set being used in a business document of a business application. UI 800 depicts a graphical representation of a purchase order 805. Additionally, the purchase order shown in FIG. 8 relates to the business partner “Akron Heating Technologies Inc.”. Continuing the example introduced earlier, this business partner is assigned to a business partner group defined in accordance with other aspects herein. The attributes defined for and associated with the business partner group set to which the business partner “Akron Heating Technologies Inc.” is assigned are imported into the purchase order of FIG. 800 as illustrated at UI element 810. As shown, the delivery tolerance attributes for the subject business partner has a value of 9% for over/under deliveries, as do all other business partners (not shown) belonging to the same business partner group set. In some aspect, the 9% attribute value is automatically imported into business document(s) based on the business partner's assignment to a business partner group set definition including that attribute and having a particular value (i.e., 9%) assigned thereto.

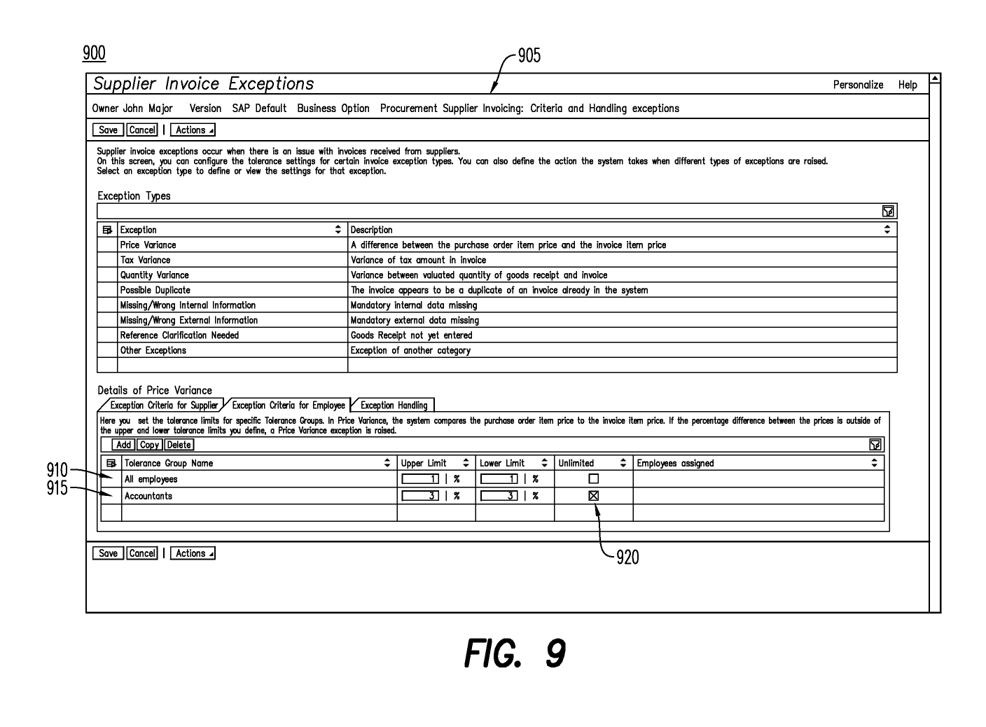

FIG. 9 is an exemplary illustration of a UI 900, according to some embodiments. UI 900 includes a depiction of a mechanism facilitating the assignment of business partners to business partner groups. The example of FIG. 9 relates to a supplier invoicing business application or service and provides a means to specify supplier invoicing criteria and exception handling for the supplier invoicing. In some aspects, multiple business groups may be defined in UI 900 as illustrated by the two example groups “All employees” group 910 and the “Accountants” group 915. For each of the specified named groups shown in FIG. 9, tolerance values are specified. In some embodiments, both upper and lower tolerance values may be specified for each business partner group. In some embodiments, one group may be categorized as a standard group, where the attribute values for the standard group applies for all business partners except for those business partners assigned to a specific other group. In the example of FIG. 9, the “All employees” group 910 may be designated the standard group and the upper limit and lower limit tolerances associated with that group may automatically apply to all employees not assigned to any group or any other group. In some aspects, at least one business partner group may resolve exceptions by being designated as having “unlimited” authority as shown at 920.

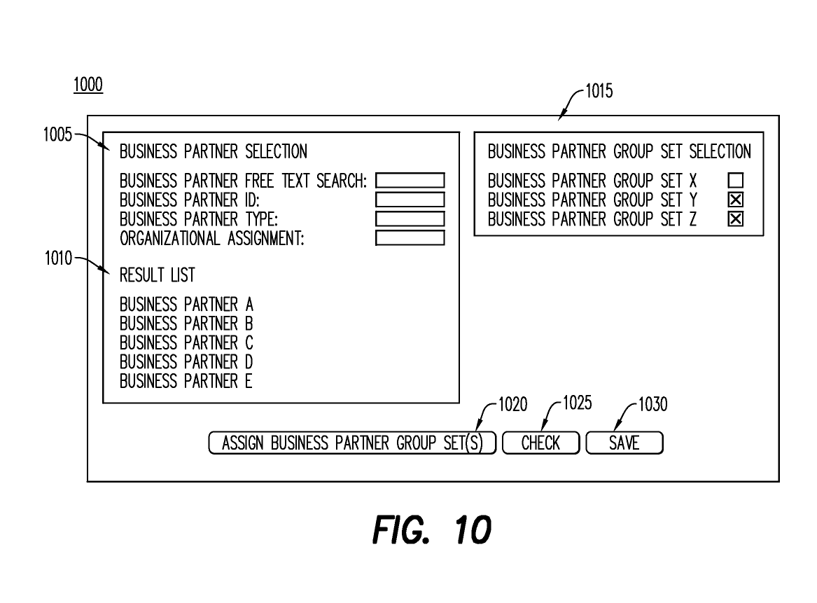

FIG. 10 is an illustrative depiction of a UI 1000 that includes various UI elements to facilitate, for example, an assignment of business partner group sets to selected business partners. In some aspects, UI 1000 may support the efficient assignment of business partner group sets to one or more selected business partners or entities (e.g., suppliers). At section 1005 of UI 1000, a number of illustrative, but not limiting, business partner selection characteristics may be indicated to specify one or more business partners. For example, a business partner type may be one of a supplier, a customer, an internal or external employee, and other values, whereas the organization assignments may refer to different organization entities within a business. The example business partner selection fields may support a single value and/or a range of input values. A result list of business partners satisfying the business partner selection characteristics identified at 1005 may be presented at 1010. UI 1015 may facilitate the assignment of select business partner group sets (e.g., the business partner groups sets having the business partner group set ID and description of “BUSINESS PARTNER GROUP SET Y” and “BUSINESS PARTNER GROUP SET Z”) to the business partners of 1010. UI element 1020 may be used to perform the task of assigning the business partner group sets to the selected business partners and UI buttons 1025 and 1030 may be used to check a functional aspect of the assignment and save the assignment, respectively. In some aspects and embodiments, the assignments facilitated by UI 1000 may be accomplished in an automated process.

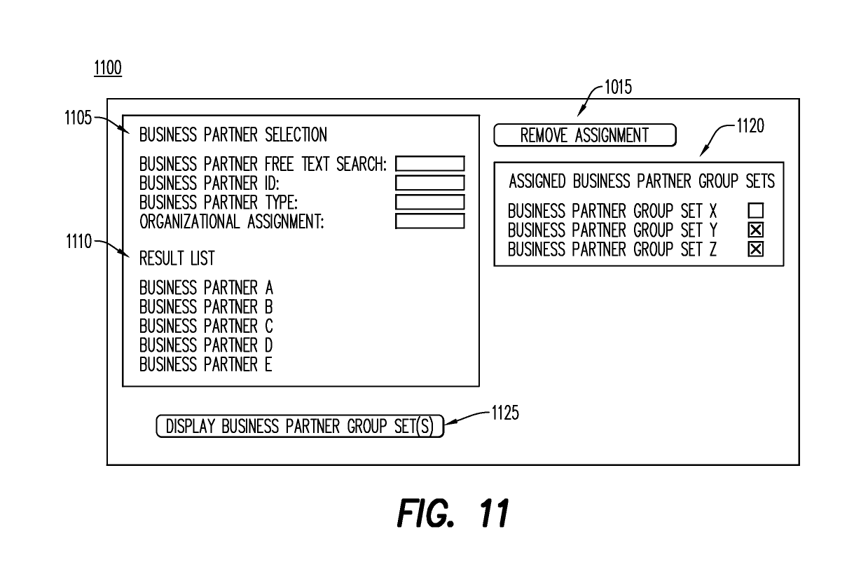

FIG. 11 is an illustrative depiction of a UI 1100 that includes various UI elements to facilitate, for example, a review and display the assignment of business partner group sets to business partners. In some aspects, UI 1100 may support the efficient review and maintenance of business partner group sets assigned to one or more selected business partners or entities. At section 1105 of UI 1100, a number of illustrative, but not limiting, business partner selection characteristics may be indicated to specify one or more business partners. For each of the business partners listed in the result list 1110 for the business partners satisfying the business partner selection characteristics identified at 1005, the associated business partner group sets assignment(s) may be displayed at display panel 1120. UI buttons 1125 and 1115 may be actuated to display business partner groups sets after the result list is obtained at 1110 and to remove one or more of the displayed assignments, respectively.

In some embodiments, a UI to facilitate the display of the business partners assigned to a certain and specified one or more business partner group sets may be provided in accordance with the present disclosure, although not separately shown in a drawing herewith.

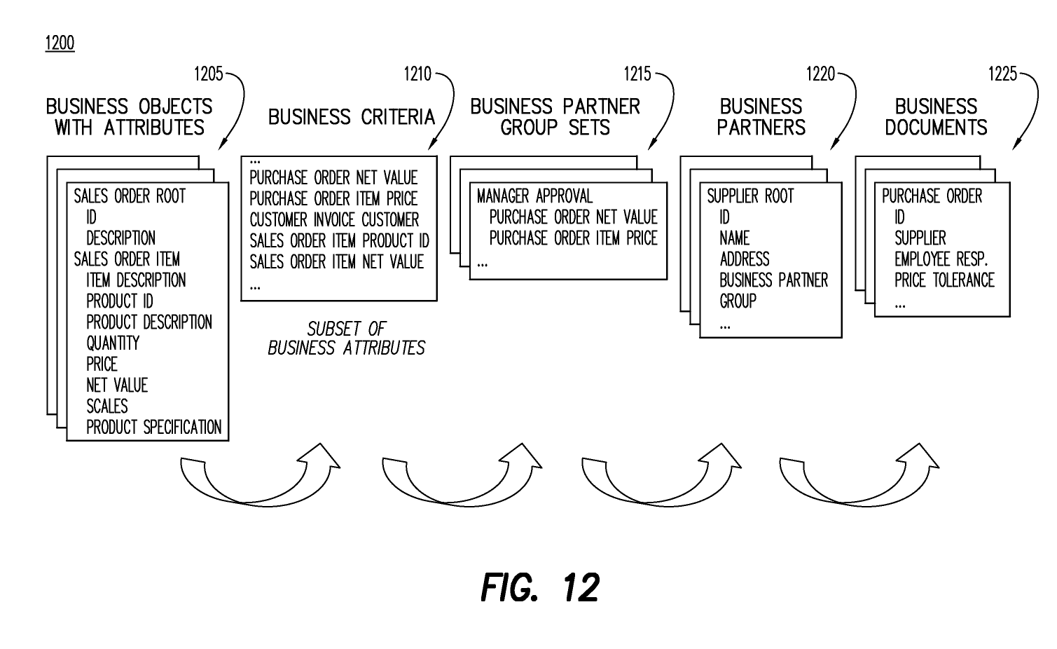

FIG. 12 is an illustrative depiction 1200 of some inter-dependencies that may exist between some of the entities disclosed herein. FIG. 12 includes illustrative, but not limiting, examples of the depicted entities. As demonstrated by FIG. 12, business objects 1205 may include business objects and all (at least some) of the attributes associated and defined for those BOs. The business criteria 1210 may include one or more of the attributes of the BOs 1205. In this manner, the business criteria 1210 may be viewed and/or referred to as a subset of the business attributes of the BOs 1215. FIG. 12 further illustrates the business criteria 1210 being used to define the business partner group sets 1215, as discussed in detail above. The business partner groups sets 1215 may be assigned to business partners 1220. The business attributes linked to defined business partner groups sets 1215 may be imported into business documents and applications 1225 when, for example, a business partner 1220 belonging to a business partner group set 1215 uses or otherwise interacts with a business document 1225 associated with the business attributes.

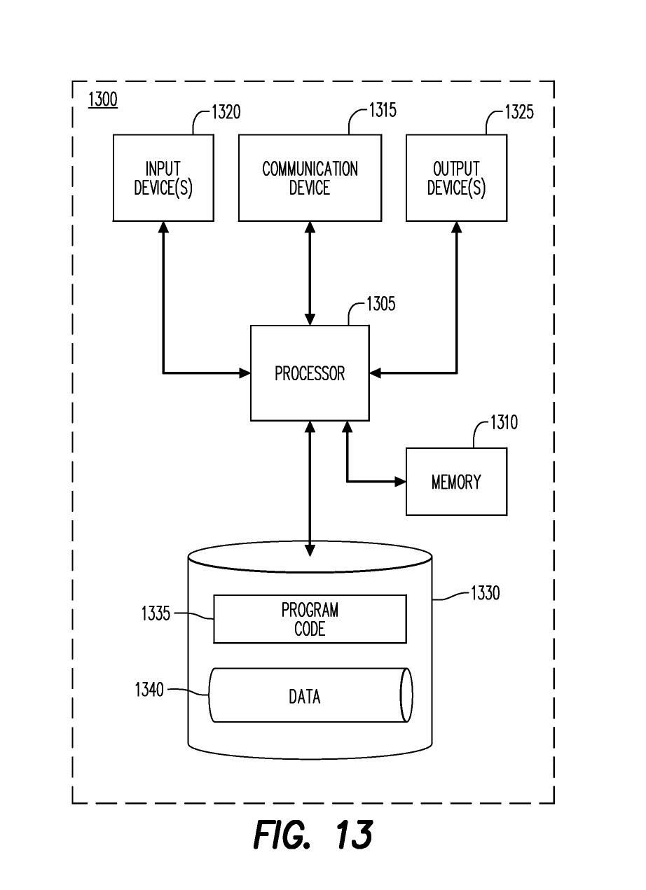

FIG. 13 is a block diagram overview of a system or apparatus 1300 according to some embodiments. The system 1300 may be, for example, associated with any of the devices described herein, including for example client 105 and a device or system in support of business application platform 115 such as, for example, an application server. The system 1300 comprises a processor 1305, such as one or more commercially available Central Processing Units (CPUs) in form of one-chip microprocessors or a multi-core processor, coupled to a communication device 1315 configured to communicate via a communication network (not shown in FIG. 13) to another device or system. In the instance system 1300 comprises an application server, communication device 1315 may provide a means for system 1300 to interface with a client device (e.g., client 105). Device 1300 may also include a local memory 1310, such as RAM memory modules. The system 1300 further includes an input device 1320 (e.g., a touchscreen, mouse and/or keyboard to enter content) and an output device 1325 (e.g., a computer monitor to display a user interface element).

Processor 1305 communicates with a storage device 1330. Storage device 1330 may comprise any appropriate information storage device, including combinations of magnetic storage devices (e.g., a hard disk drive), optical storage devices, and/or semiconductor memory devices. In some embodiments, storage device may comprise a database system.

Storage device 1330 stores a program code 1335 that may provide computer executable instructions for processing requests from, for example, client devices in accordance with processes herein. Processor 1305 may perform the instructions of the program 1335 to thereby operate in accordance with any of the embodiments described herein. Program code 1335 may be stored in a compressed, uncompiled and/or encrypted format. Program code 1135 may furthermore include other program elements, such as an operating system, a database management system, and/or device drivers used by the processor 1305 to interface with, for example, peripheral devices. Storage device 1330 may also include data 1340. Data 1340 may be used by system 1300, in some aspects, in performing the processes herein.

In accordance with various aspects herein, some embodiments may provide mechanisms for an effective and efficient maintenance of business partner attributes for groups of business partners.

The present disclosure supports business application platforms business applications, and business services that include enhanced transparency, easier system and record maintenance, and fast responsiveness to new business opportunities and market challenges. Additionally, embodiments herein may provide solutions without a need to resort to further rule engines or software business configurations in order to, for example, assign the same attribute(s) to a group of business partners.

Embodiments have been described herein solely for the purpose of illustration. Persons skilled in the art will recognize from this description that embodiments are not limited to those described, but may be practiced with modifications and alterations limited only by the spirit and scope of the appended claims.

What is claimed is:

1. A computer-implemented method executable by a computer, the method comprising:
defining business criteria for business entities, the business criteria including at least one business object attribute;
defining at least one business partner group set, each of the at least one business partner group set being associated with at least one business object attribute selected from the business criteria; and
modifying, by the computer, a record of a business entity by assigning the business entity to one or more of the defined business partner group sets.

2. The method of claim 1, wherein the at least one business object attribute is selected from pre-existing attributes associated with existing business objects, attributes newly defined in conjunction with the defining of the business criteria, and combinations thereof.

3. The method of claim 1, further comprising:
assigning a unique identifier to each of the at least one business partner group sets, wherein the modifying of the record of a business entity by assigning the business entity to one or more of the defined business partner group sets references the unique identifier.

4. The method of claim 1, wherein multiple business object attributes may be associated with the defined at least one business partner group set.

5. The method of claim 1, further comprising assigning a value to each of the at least one business object attribute associated with the business criteria of the at least one business partner group set.

6. The method of claim 5, further comprising importing the values of the at least one business object attribute associated with the business criteria of the at least one business partner group set into a business document.

7. The method of claim 1, wherein the record of the business entity is a master data record associated with the business entity.

8. The method of claim 1, wherein a field is added to the record of the business entity to accommodate the assigning of the business entity to one or more of the defined business partner group sets.

9. The method of claim 1, wherein a change to a business document attribute in a defined business partner group set is automatically reflected in the business entities assigned to the defined business partner group set.

10. The method of claim 1, wherein the defining of the at least one business partner group set further includes ranking a plurality of business partner groups sets in the at least one business partner group set, wherein a lower ranking business partner group set inherits business document attributes of a higher ranking business partner group set.

11. The method of claim 1, further comprising assigning the at least one business partner group set to the business entity.

12. A computing system comprising:
a memory storing processor-executable instructions; and
a processor to execute the processor-executable instructions to cause the system to:
define business criteria for business entities, the business criteria including at least one business object attribute;
define at least one business partner group set, each of the at least one business partner group set being associated with at least one business object attribute selected from the business criteria; and
modify a record of a business entity by assigning the business entity to one or more of the defined business partner group sets.

13. The system of claim 12, wherein the at least one business object attribute is selected from pre-existing attributes associated with existing business objects, attributes newly defined in conjunction with the defining of the business criteria, and combinations thereof.

14. The system of claim 12, the processor to further execute the processor-executable instructions to assign a unique identifier to each of the at least one business partner group sets, wherein the modifying of the record of a business entity by assigning the business entity to one or more of the defined business partner group sets references the unique identifier.

15. The system of claim 12, wherein multiple business object attributes may be associated with the defined at least one business partner group set.

16. The system of claim 12, further comprising assigning a value to each of the at least one business object attribute associated with the business criteria of the at least one business partner group set.

17. The system of claim 16, further comprising importing the values of the at least one business object attribute associated with the business criteria of the at least one business partner group set into a business document.

18. The system of claim 12, wherein the record of the business entity is a master data record associated with the business entity.

19. The system of claim 12, wherein a field is added to the record of the business entity to accommodate the assigning of the business entity to one or more of the defined business partner group sets.

20. The system of claim 12, wherein a change to a business document attribute in a defined business partner group set is automatically reflected in the business entities assigned to the defined business partner group set.

21. The system of claim 12, wherein the defining of the at least one business partner group set further includes ranking a plurality of business partner groups sets in the at least one business partner group set, wherein a lower ranking business partner group set inherits business document attributes of a higher ranking business partner group set.

22. The system of claim 12, further comprising assigning the at least one business partner group set to the business entity.
